(19) United States
(12) Patent Application Publication
(10) Pub. No.: US 2011/0162487 A1
(43) Pub. Date: Jul. 7, 2011

(54) WIRE TWIST CONNECTOR TOOL

(76) Inventor: Kevin F. Cline, Medina, OH (US)

(21) Appl. No.: 13/014,287

(22) Filed: Jan. 26, 2011

Related U.S. Application Data
(63) Continuation-in-part of application No. 12/319,600, filed on Jan. 8, 2009, now abandoned.
(60) Provisional application No. 61/134,830, filed on Jul. 14, 2008.

(51) Int. Cl. H01R 43/22; B25B 13/48; B25B 13/46

(52) U.S. Cl. 81/60; 81/125; 29/750

(57) ABSTRACT

A tool for installing a wire twist connector onto at least two wires includes an injection molded device having a through orifice arranged on a distal face of the device for accepting a wire twist connector. This through orifice includes a through opening and a plurality of tapered curved regions arranged therein for contacting ridges on an exterior of the wire twist connectors during installation and removal. Pairs of stepped shoulders are arranged within the through orifice for accepting wings on an exterior of the wire twist connectors.

The present application is a continuation-in-part of U.S. application No. Ser. No. 12/319,600, filed Jan. 8, 2009, which claims the benefit from U.S. Provisional Application No. 61/134,830 filed on Jul. 14, 2008, both of which are incorporated by reference in their entireties.

The present invention did not receive federal research and development funding.

### TECHNICAL FIELD

The present disclosure relates to tools that couple wires together by a mechanical device wire twist connector wire twist connector. The wire twist connector wire twist connector is placed over bared conductive ends of wires wherein the wires are conductively joined by a rotational motion.

### BACKGROUND OF THE INVENTION

For years, electricians have used wire twist connectors (i.e. such wire twist connectors are often sold under the trademark commonly known as Wire-nuts®) for connecting electrical wires together. The electrician typically twists the wires together and eels the ends with electrician's pliers. Thereafter, a wire twist connector is installed onto the wires to maintain electrical continuity between them. For purposes of this disclosure, “wire twist connector” is given its ordinary meaning as understood by a licensed electrician. Wire twist connector are made up of an elongated shell, covered with pliable insulation. The shell is enclosed at only one end. The other end of the shell is longitudinally hollow with a threaded metal connecting socket coupled within the hollowed shell. Typically, the connecting socket is comprised of a conductive material such as metal or aluminum. Many wire twist connectors also have outwardly extending wings, which aid in gripping and turning the wire twist connector during installation. Other wire twist connectors can come without wings and typically include raised ridges on the exterior for aiding in gripping the wire twist connector when installing or removing them. Wire twist connectors are available in many different sizes and shapes.

Generally, wire twist connector are manually connected onto the ends of the wires to electrically and mechanically couple the wires together. To connect two or more wires using a wire twist connector, the user aligns the ends of the wires so they are even, then the wire twist connector is placed over the ends of the wires and twisted by hand until secure. The wires become threaded within the socket of the wire twist connector and twist or are pressed together creating electrical continuity between the wires. Wire sizes generally associated with the use of wire twist connectors range from 14 gauge through about 8 gauge. To obtain an effective connection, a great deal of pressure must normally he applied by hand, and more specifically, by the user's fingers which can cause calluses, cramps, tenderness, numbness and/or tingling. The repetitive action involved in manually connecting a large number of wire twist connectors can even result in the user being afflicted by carpel tunnel syndrome. If ample pressure is not applied, the wire twist connector will not be connected securely. Loose wire twist connections may cause circuit failure and/or electrical arcing within the wire twist connector which tends to melt the plastic shell of the wire twist connector and may lead to a fire. In wiring a single building, electricians install large numbers of wire twist connectors by hand which is slow and tedious.

Other wire twist connector tools have helped solve some of these problems, but not enough to be accepted by all in the field. Prior art wire twist connector tools are often bulky and/or ineffective. The use of pliers on wire twist connector wire can. result in cracking of the plastic shell and a risk of open circuits. Some wire twist connector wrenches are time consuming to use due to the wire twist connector becoming jammed in the tool. These wrenches generally result in a longer installation time than if the wire twist connector had just been manually installed. Other wrenches only install one or two types of wire twist connectors. Electricians and other users arc thus forced to carry multiple wire twist connector tools. Finally, some wrenches are fabricated from metal or aluminum, which raises the risk that the installer will experience an electrical shock when applying the wire twist connector to electrical wires.

By way of example, some of the prior art devices that have been used to install wire twist connector include U.S. Pat. No. 4,860,618 to Givot. Givot discloses a generally cylindrical in shape tool sized to fit a normal sized hand. The cylinder has a wire twist connector receptacle opening in the base. A wire twist connector is inserted into the receptacle and is secured to the wires. In a second embodiment, two receptacles are include with one placed on each end of the cylinder. The receptacles are sized to accommodate different styles of wire connectors. Third and fourth embodiments are identical to the first and second except for the addition of a ratchet mechanism installed within the body of the cylinder.

U.S. Pat. No. 5,806,382 to Hall, Jr. discloses a wire end connector tool designed for use with a standard wire connector cap for crimping the ends of wires together. The tool consists of a cylindrical handle of a thickness to fit comfortably in a user's hand and an axial member longer than the handle, rotationally captured in and extending through the cylindrical handle and able to rotate therein. One or both ends of the axial member protrude from the end(s) of the cylindrical handle. Each protruding end is formed into a helical coil with its axis parallel to, but spaced from, the axis of the handle. Each coil is designed to securely accept standard wire connector caps such as those described above and to prevent it from rotating. This allows wires to be connected with a simple wrist rotation rather than requiring manual twisting with the fingers.

U.S. Pat. No. 5,974,916 to Lassiter discloses a wire twist connector driver including a ratchet ball which drives a socket. The ratchet ball is formed with a center opening which allows the ratchet ball to receive a stem of the socket in either end thereof for rotation in either the clockwise or counterclockwise direction. The socket is formed with a center bore. The center bore is formed by a plurality of alternating channels and ribs which engage complementary shaped channels and ribs of a wire twist connector. Rotation of the ratchet hail produces rotation of the socket and wire twist connector for attaching the wire twist connector to a plurality of wires for electrically connecting the wires together. A pair of slots are formed in an open end of the socket adjacent the center bore for receiving a wing nut-type wire twist connector.

None of the prior art wire twist connector tools have alleviated the present difficulties of installing wire twist connectors efficiently and safely. Present tools accommodate insertion of the wire twist connectors but fall to adequately secure the wire twist connectors in the aperture. Consequently, most wire twist connectors are still installed by hand. A more efficient, secure means is needed for greater ease and reliability to speed-up the installation process. To that end, the instant application aims to provide a novel tool that comprises an offset opening that receives a wire twist connector for installation through a rotation of the handle about an axis of rotation that intersects the center of both ends of the wire twist connector being installed.

### SUMMARY OF THE INVENTION

The wire twist connector tool of the present invention is designed to install or remove wire twist connectors simply and expeditiously by spinning the wire twist connectors on or oft electrical wires by rotating the handle of the wire twist connector tool, and the body of a wire twist connector tool about a central axis defined by a wire twist connector situated within a wire twist connector through orifice in the body of the wire twist connector tool. For purposes of this disclosure, the terms “proximal” and “distal” are defined with respect to the handle of the tool.

In an embodiment, the through orifice is a tapered channel with the larger diameter being at the distal face of the body and a smaller diameter at the proximal face of the tool body. The through orifice is a series of specially arranged regions of tapered flutes for gripping the ridges/grooves of a wire twist connector and pairs of stepped ridges that receive wire twist connectors with wings.

In an embodiment a handle, a wire twist connector tool body, and a shaft extending from the tool body which is received within a shaft aperture formed in the handle that allows the handle to rotate relative to the tool body are included. The tool body contains a wire twist connector aperture that is offset from a handle axis extending through the center of the handle and shaft and which receives the wire twist connectors.

In another embodiment the wire twist through orifice has a plurality of flutes located along its inner circumference. These flutes are tapered and adapted to receive wingless wire twist connectors of various sizes and engage with small grooves or ridges found on many wire twist connectors, with or without wings.

In another embodiment wire twist connector aperture also includes a plurality of pairs of deeper slots intermixed with the tapered flutes. These slots are arranged in pairs spaced on opposite sides of a central opening across from one another to accommodate a plurality of different sized wire twist connectors having wings.

In another embodiment, the handle rotates freely relative to the tool body. The shaft of the present invention is connected to a separate handle via a rotatable connection. The rotatable connection may be a “C” type washer or clamp that is coupled within a recess in the handle near the distal end of the shaft. The “C” type washer allows the shaft to spin freely within the handle on the inner surface of the “C” type washer. Otherwise, the shaft may have a flared end having a larger diameter than the remaining portion of the shaft. Additionally, the holder body may be injection molded from nylon with the shaft integrally coupled within the nylon.

In another embodiment the tool wire twist connector is made of nonconductive materials to protect the user from the potential risk of electrical shock. In one instance, the body may be formed from a molded plastic or composite material. The free end of the handle includes a comfortable grip having rubber or other nonconductive material.

In an additional embodiment, the wire twist connector holder is provided with a square shaft aperture for accepting an end of a separate socket drive handle. In this manner, the wire twist connector holder may be coupled with a reversible socket drive or handle for use in installing and/or removing wire twist connectors. In this manner the handle with the ratcheting mechanism may be substituted tor the shaft and handle assembly as described in the embodiment of paragraph [0016]. The phrase “socket drive handle” refers to a known ratcheting mechanism, for example a ratcheting driver as set forth in U.S. Pat. No. 7,421,772 to Gao et al. which is incorporated herein by reference.

In a another embodiment, the wire twist connector tool is provided with a third opening that is preferably arranged between the wire twist connector aperture and where the axis of the handle is coupled to the tool body. The third opening is to receive the shaft of a tool that is inserted and be of a shape consistent to receive a tool shaft. The third opening may he hexagonal, square, six or twelve points to receive a tool shaft having a first end formed, as a screw driver head or socket drive. It should be recognized that square shaft aperture for accepting tools such as screwdriver heads and nut drivers may he arranged at various locations on the opposite face of the holder body.

In another embodiment the tool reduces risk of fire associated with a loose wire twist connector and faulty electrical connection by providing a tool that assists an electrician in installing a wire twist connector.

In another embodiment the tool ensures electrical conductivity of an electrical connection between at least two power supplying wires.

In another embodiment the tool reduces the risk of ergonomic injuries experienced by electricians wire twist connector by reducing the amount of torque applied by the electrician to generate the proper amount of torque to the wire twist connector. A wire twist connector that is properly applied will require sufficient torque to show twisting of the wires below the open end of the wire twist connector. In circumstances where the wire is 14 gauge or larger the twisting applied to the wire twist connector by hand can be significant and harmful when performed in repetition.

In another embodiment the inserted tool opening has a magnet in the bottom of the opening to attract a steel inserted tool.

In another embodiment the body has a magnet adhered to the inside of the body opening for receiving the ratcheting handle.

In another embodiment the second end of the handle has a lanyard attached.

In another embodiment the tool has a light in the handle facing toward the handle first end and tool to aid in visualizing the electrical connections.

In another embodiment the wire twist connector tool that accepts a wire twist connector for coupling at least two conductors together having a tool body with a through orifice for receiving a wire twist connector near the tool body first end and a shaft integrally attached to the tool body second end. The through orifice has a diameter at the distal face greater than a diameter at the proximal face along the orifice axis with tapered flutes. The shaft handle end extends substantially perpendicular to a proximal face of the tool body and the shaft handle end also has a shaft collar and a clamp. There is a handle having a handle first end and a handle second end where the handle first end has a handle orifice substantially about a linear axis of the handle for receiving the shaft handle end. The handle orifice allows for securing the shaft handle end from linear motion allowing rotation of the shaft handle about the handle axis. The wire twist connector is secured in the through orifice such that at least two conductors are placed within the wire twist connector and the handle and shaft handle end rotates in an arcuate path about an axis of the wire twist connector. The rotational motion provided to die wire twist connector twists the at least two conductors within the wire twist connector.

The wire twist connector tool body is non-conductive. Also, the wire twist connector tool through orifice has a plurality of curved regions that mate with ridges and grooves on an exterior surface of a wire twist connector. The through orifice may also have pairs of stepped ridges that are arranged symmetrical to one another for accommodating wings on an exterior of a wire twist connector.

The tool body may also have an opening arranged in the tool body between the through orifice and the handle axis for accessory tools. The handle may have a light emitting assembly to assist in visual identification of work components. A lanyard may also be attached to the handle. In an embodiment the handle may have a ratcheting mechanism where the ratcheting handle shaft allows for rotational motion about the handle axis when removeably inserted into the drive opening found in the proximal face of the tool body second end. The drive opening receives the ratcheting handle shaft end. The handle has a ratcheting mechanism about the axis of the handle.

The tool body may have an accessory opening between the handle axis and the through orifice axis shaped to receive accessory rotatable tools. The accessory opening retains a magnet for holding the accessory rotatable tools.

The wire twist connector tool may also be a kit having a tool body with a through orifice for receiving a wire twist connector near the tool body first end and a drive opening in the proximal face of the tool body second end. The drive opening receives a shaft end integral to a ratcheting handle with a first end and a handle second end. The handle first end has the handle shaft end substantially about a linear axis of the handle for inserting the handle shaft end into the drive opening. The ratcheting handle shaft allows for rotational motion about the handle axis when the ratcheting handle shaft and tool body drive opening are removeably joined.

Further objects, features and advantages of the invention will become apparent from a consideration of the following description and the included claims when taken in connection, with the previous discussion and the accompanying drawings. The above explanations are provided to illustrate the utility of the invention. And, by no means are these explanations intended to limit the application of this invention from being used for other purposes.

### DESCRIPTION OF THE DRAWINGS

FIG. 1 shows a partial cross section view of the body and rotating handle

FIG. 2 is a distal end view of the took wire twist connector

FIG. 3 shows the through orifice wire twist connector.

FIG. 4 shows another embodiment of the orifice for accommodating the wings of modern wire twist connectors.

FIG. 5A shows the proximal face having a square opening for accommodating an end of a socket wrench or ratcheting screwdriver handle.

FIG. 5B shows a partial cross section view of the tool body with a ratcheting screw driver handle.

FIG. 6A shows a tool body with a central opening for accepting a tool.

FIG. 6B shows an assembly of FIG. 6A with a handle.

FIG. 6C shows a screwdriver tip arranged in front of the distal face of the tool.

FIG. 6D shows a screwdriver tip inserted into the central opening.

FIG. 7 shows two types of prior art wire twist connectors that may be used in connection with the invention.

### DETAILED DESCRIPTION OF THE INVENTION

This tool is not limited by the discussion of the various embodiments and should only be defined by the claims. Moreover, it should be recognized that this invention is not limited by the discussion of the embodiments, but that skilled artisans may easily recognize that certain modifications may be made without deviating from the spirit of the invention.

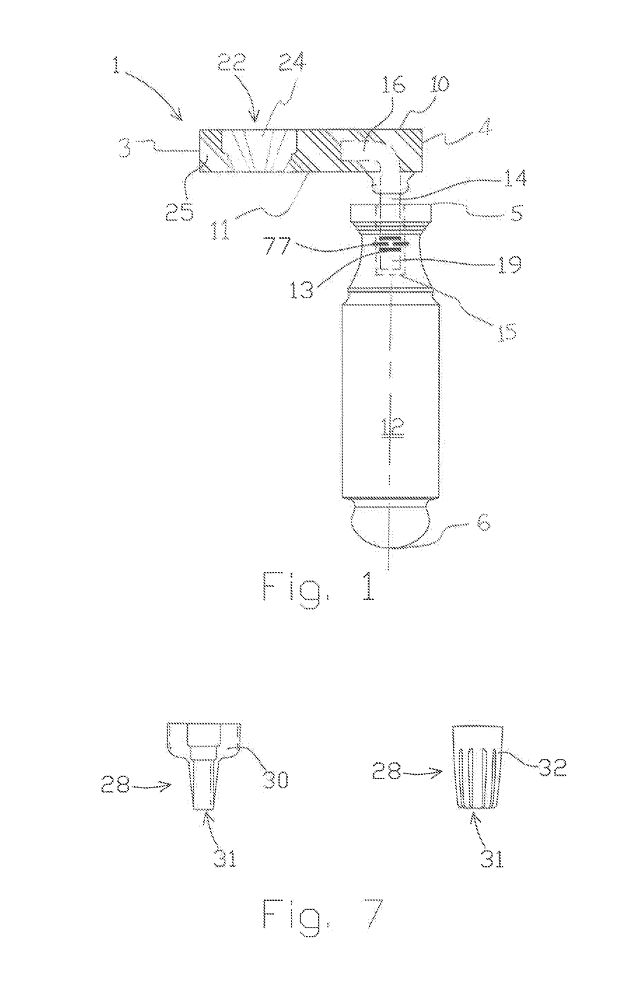

FIG. 1 shows an embodiment wherein the tool 1 includes a rotating handle 12 and is taken from line A-A of FIG. 2. As can be understood, wire twist connector with wings 28, or wire twist connector 28′, shown in FIG. 7, are inserted with closed end 31 into a through orifice 22 of body 25. Through orifice 22 includes specially arranged regions or tapered flutes 24 for either gripping the ridges/grooves 32 provided on wire twist connector 28′ or accommodating the wings 30 provided on wire twist connector with wings 28. In this instance, the through orifice 22 is larger in diameter on the distal face of the tool 10 than the proximal face 11. Shaft 14 includes distal cud 16 and handle end 19 that may include a shaft collar 13 for accepting a clamp 77 to secure the handle 12 to shaft 14 in a free spinning manner. That is, the handle end 19 of the shaft rotates freely relative to the handle 12. Tool 1 may be easily spun about an end of two or more wires in a quick fashion to install a wire twist connector. Otherwise, the wire twist connector through orifice 22 may be arranged around a wire twist connector and the nut may he spun in a counterclockwise direction to remove the wire twist connector. In an embodiment, body 25 is formed from a plastic material that is easily formed and is nonconductive. The shaft 14 is preferably formed from metal. The handle 12 may include a rubber grip and is formed from nonconductive material. The handle 12 includes a handle orifice that accepts the straight handle end 19 of the shaft 14. Thereafter, the clamp 77 is seemed about collar 13 to prevent the handle 12 from slipping off of the shaft 14. In this manner, the shaft 14 and handle 12 are coupled together preventing axial motion yet allowing for rotational motion. The rotational motion relates to the handle 12 rotating about the axis of the shaft 14 at the handle end 19.

Tool body 25 defines a through orifice 22 as a tapered channel with a larger diameter at the distal face 10 of the body 25 and a smaller diameter at the proximal face 11. The through orifice 22 includes a series of specially arranged, tapered flutes 24 for gripping the ridges/grooves 32 of a wire twist connector 28′ and pairs of stepped ridges that receive wire twist connectors with wings 30. Tapered flutes 24 shown in FIG. 2 are curved flutes that arc larger opening diameter or exposure at the distal face 10 than on the proximal face 11. Tapered flutes 24 provide a high amount of surface area, and therefore provide improved contact for better gripping of a wire twist connector 28′ without wings. The number of tapered flutes 24 may equal the number of ridges/grooves 32 found on the surface of a wire twist connector 28, 28′. In particular the effective gripping of wire twist connectors 28, 28′ becomes critical when connecting heavier gauge wires, such as 10 or 8 gauge. In addition, the tapered flutes 24 may be textured or smooth, or over coated with a more compliant polymer. In some embodiments, the through orifice 22 taper is between seven (7) and twenty two (22) degrees tapering inwardly from the distal face 10 to the proximal face 11 also for improved gripping.

The through orifice 22, having an opening at the proximal end also accommodates wire twist connectors 28, 28′ that have pigtail openings. The pig tail opening wire twist connectors 28, 28′ are not closed at the “closed” end, but provide an opening to allow a single conductor to protrude through the end. The main purpose is to allow connecting of several wires together where one of the twisted conductors will be connected to a terminal, or in the case of a ground wire, to a junction box.

Also shown in FIG. 1, the body 25 may be substantially uniform in thickness from the proximal face 11 to distal face 10. The distal end 16 of shaft 14 is unitarily secured within the body 25 such that lateral motion applied to handle 12 rotates body 25 around the axis of the through orifice 22 and wire twist connector 28, 28′ secured by the twisted flutes 24 within.

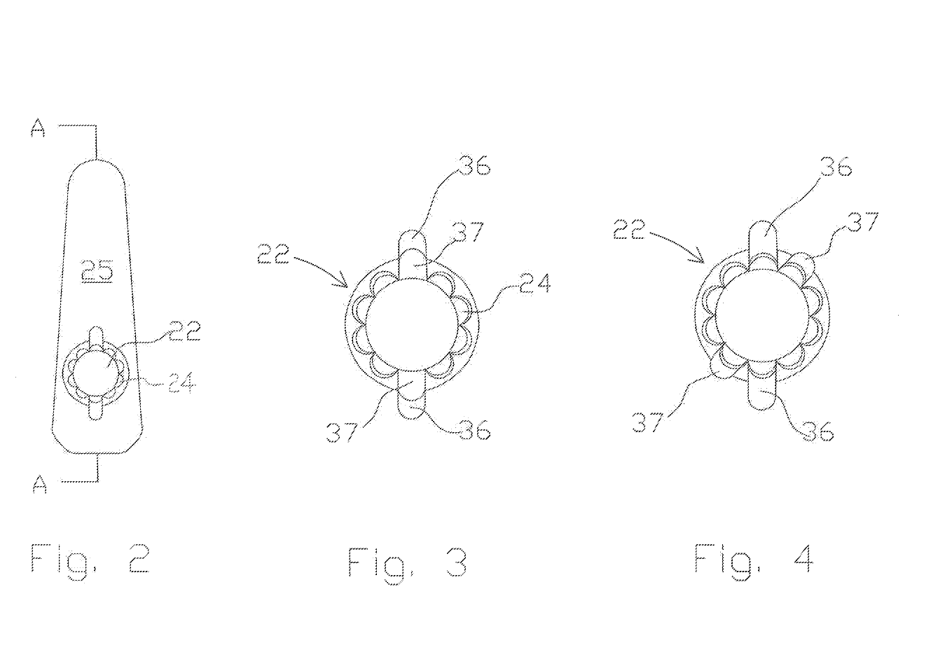

FIG. 2 shows a distal face 10 and end of the tool 1. The tool 1 includes the wire twist connector through orifice 22 having tapered flutes 24 that mate with the ridges/grooves 32 of wire twist connector 28′. As can be better understood by FIG. 3, the through orifice 22 also includes pairs of stepped ridges 36, 37 that are arranged symmetrical to one another and for accommodating wings on standard yellow and red wire twist connectors with wings 28. Where the terms yellow and red are understood to be the most common wire twist connectors with wings 28 used by electricians in the art, it should be realized that other sizes may be provided and are generally intended for 14-8 gauge conductors. In FIG. 3, the stepped ridges 36, 37 are aligned with one another as shown. In FIG. 4, the stepped ridges 36 and 38 are provided out of phase with one another as shown to compensate for wire twist connectors with wings 28 of different sizes for use with varying gauge wires.

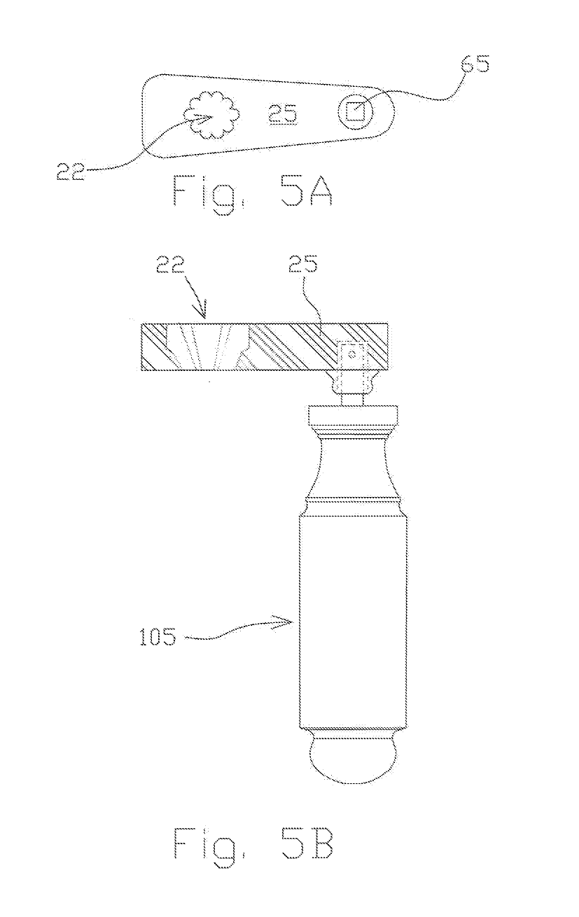

FIGS. 5A and 5B show an additional embodiment of the tool 1 where the proximal face 11 of the tool 1 includes a drive opening 65 for accepting an end of a square drive ratcheting drive 105. As shown in FIG. 5B, the tool 1 is shown coupled to a square driver handle 105 or other such ratcheting drive device. Rotational movement of the ratcheting drive 105 about the axis of through orifice 22 operates in the opposite manner of a ratcheting handle 105 in a tightening direction. Observing from the handle second end 6 movement of the ratcheting handle 105 in a clockwise motion to tighten the wire twist connectors 28, 28′ allows the ratcheting mechanism to operate freely rotating around the shaft of the ratcheting handle 105. When rotating the ratcheting handle 105 in a clockwise direction to loosen the wire twist connectors 28, 28′ the handle would be locked and not rotatable around the shaft of the ratcheting handle 105. In this manner, rotation of the ratcheting handle 105 around the ratcheting handle shaft is the opposite of customary use of the ratcheting handle 105. Similarly, switching the ratcheting direction for customary use locks the ratcheting handle 105 from movement around the ratcheting handle shaft when rotating in the counter clockwise direction.

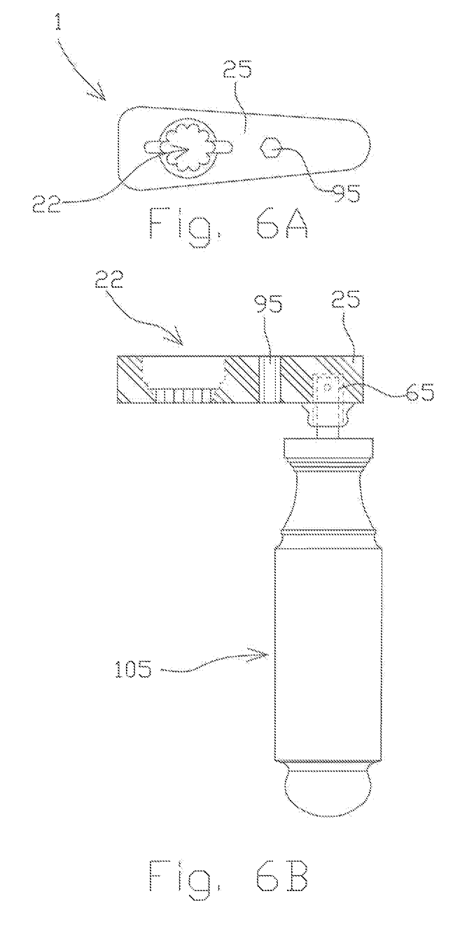

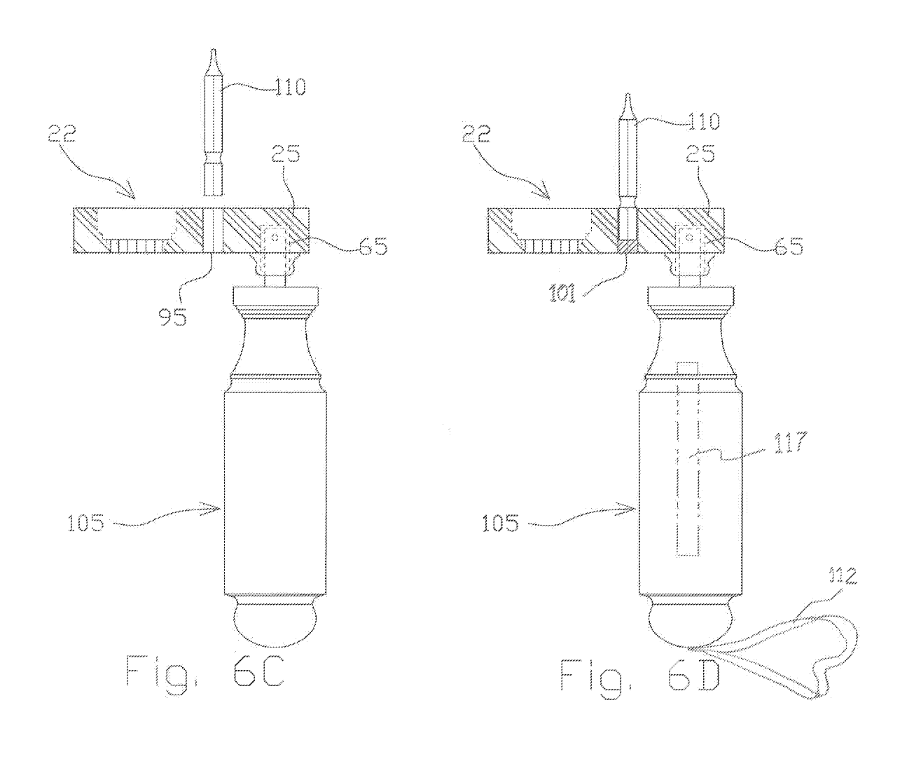

FIGS. 6A-6D show further embodiments of the invention where an accessory opening 95 may he provided in the distal face of the tool 1, as shown in FIG. 6A. Opening 95 is preferably a hexagon shaped orifice and may extend through as an accessory opening 95 traversing the body 25, or alternatively may be a closed accessory opening 95. A closed opening 95 may contain a magnet 101 at the proximal face 11 to aid in retaining any steel tool that may be inserted.

In FIGS. 6B-6D, an insert tool 110, shown in the figures as a screwdriver tip, may be inserted to the accessory opening 95 as shown. Sockets or other nut drivers may be inserted into the accessory opening 95. Screws or other nuts may be installed or removed with the insert tool 110 inserted into the accessory opening 95. The accessory opening 95 is arranged substantially midway between the axis of the drive opening 65 which receives an end of the ratcheting drive 105 and the through orifice 22. As with the through orifice 22, by providing the accessory opening 95 offset to the handle, a greater torque may be exerted on screws or nuts when installing or removing them. When used, a wire twist connector 28, 28′ is deposited into the through orifice 22 and wires are inserted into the open end of the wire twist connector 28, 28′. Thereafter, the body 25 of the tool 1 is rotated in a clockwise manner such that the handle 12 spins counter-clockwise to the body 25. To remove a wire twist connector 28, 28′, the through orifice 22 is placed atop a wire twist connector 28, 28′ and rotated in a counter-clockwise manner. This in turn causes the handle 12 to rotate in a clockwise manner with respect to the body 25.

Additionally a magnet 101 may be fastened into the body 1 in the drive opening 65 to aid in retention of the ratchet handle 105. Also shown are additional embodiments such as a lanyard 112 attached to the second end 6 of the handle 12, 105, a light assembly 117 contained within the handle 12, 105.

The foregoing embodiments may also be provided in the form of a convenient kit for a wire twist connector tool that receives a wire twist connector for coupling conductors together. This kit may provide a tool body as described above along with a ratcheting handle, wherein the ratcheting handle shaft and tool body drive opening may be removeably joined.

While the invention has been described with respect to preferred embodiments, it is intended that all matter contained in die above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

1. A wire twist connector tool that receives a wire twist connector for coupling at least two conductors together, said wire twist connector tool comprising:
a tool body comprising a distal face and a proximal face, the tool body defining a through orifice for receiving a wire twist connector near a first end of the tool body and a shaft integrally attached to a second end of the tool body, the shaft having a shaft handle end and a shaft handle distal end wherein the shaft handle end extends substantially perpendicularly to the proximal face of the tool body, wherein the through orifice has a larger distal diameter at the distal face than a proximal diameter at the proximal face, the tool body defining a plurality of tapered flutes wherein each of the tapers is larger at the distal face than the proximal face for receiving the wire twist connector running along the through orifice from the distal face to the proximal face;
the shaft handle end comprising a shaft collar and a clamp;
a handle comprising a handle first end and a handle second end for gripping about a linear axis, said handle first end defining a handle orifice substantially about the linear axis of the handle for receiving the shaft handle end wherein the handle orifice allows for removeably securing the shaft handle end from linear motion and for rotation of the shaft handle about the handle axis; and
wherein, when the wire twist connector is received in the through orifice and at least two conductors are placed within the wire twist connector and the handle and shaft handle end is rotated in an arcuate path about an axis of the wire twist connector providing rotational motion to the wire twist connector, the rotational motion of the wire twist connector twists the at least two conductors within the wire twist connector.

2. The wire twist connector tool of claim 1, wherein the tool body is non-conductive.

3. The wire twist connector tool of claim 1, wherein the plurality of tapered flutes run along the through orifice from the distal face to the proximal face in helical fashion.

4. The wire twist connector tool of claim 1, wherein the tool body defines a through orifice with pairs of stepped ridges that are arranged symmetrically for accommodating wings on an exterior of the wire twist connector.

5. The wire twist connector tool of claim 1, wherein the tool body defines an accessory tool opening arranged in the tool body between the through orifice and the handle axis.

6. The wire twist connector tool of claim 5, wherein the accessory tool opening retains a magnet for attracting the accessory tools.

7. The wire twist connector tool of claim 1, wherein the handle comprises a light emitting assembly for illuminating a work area about the wire twist connector.

8. The wire twist connector tool of claim 1, wherein the handle further comprises a lanyard attached to the handle.

9. The wire twist connector tool of claim 1, wherein the through orifice distal diameter and proximal diameter define a taper in the through orifice between seven and twenty two degrees.

10. A wire twist connector tool that receives a wire twist connector for coupling at least two conductors together, said wire twist connector tool comprising:
a tool body comprising a distal face and a proximal face, the tool body defining a through orifice for receiving a wire twist connector near a first end of the tool body and a drive opening in the proximal face of a second end of the tool body, wherein the drive opening receives a shaft end integral to a ratcheting handle, wherein the through orifice has a larger distal diameter at the distal face than a proximal diameter at the proximal face, the tool body defining a plurality of tapered flutes wherein each of the tapers is larger at the distal face than the proximal face for receiving the wire twist connector running along through the orifice from the distal face to the proximal face;
the ratcheting handle comprising a handle first end and a handle second end for gripping about a linear axis, said handle first end defining the handle shaft end substantially about the linear axis of the handle for removeably securing the handle shaft end into the drive opening restricting linear motion wherein the ratcheting handle shaft allows for rotational motion about the handle axis: and
wherein, when the wire twist connector is received in the through orifice and at least two conductors are placed within the wire twist connector and the handle and shaft handle end is rotated in an arcuate path about an axis of the wire twist connector providing rotational motion to the wire twist connector, the rotational motion of the wire twist connector twists the at least two conductors within the wire twist connector.

11. The wire twist connector tool of claim 10, wherein the plurality of tapered flutes run along the through orifice from the distal face to the proximal face in helical fashion.

12. The wire twist connector tool of claim 10, wherein the tool body defines a through orifice with pairs of stepped ridges that are arranged symmetrically for accommodating wings on an exterior of the wire twist connector.

13. The wire twist connector tool of claim 10, wherein the tool body defines an accessory tool opening arranged in the tool body between the through orifice and the handle axis.

14. The wire twist connector tool of claim 13, wherein the accessory tool opening retains a magnet for attracting the accessory tools.

15. The wire twist connector tool of claim 10, wherein the handle contains a light emitting assembly for illuminating a work area about the wire twist connector.

16. The wire twist connector tool of claim 10, wherein the handle comprises a lanyard attached to the handle.

17. The wire twist connector tool of claim 10, wherein the through orifice distal diameter and proximal diameter define a taper in the through orifice between seven and twenty two degrees.

18. A kit for a wire twist connector tool that receives a wire twist connector for coupling at least two conductors together, said kit comprising;
a tool body comprising a distal face and a proximal face, the tool body defining a through orifice for receiving a wire twist connector near a first end of the tool body and a drive opening in the proximal face of a second end of the tool body, wherein the drive opening receives a shaft end integral to a ratcheting handle, wherein the through orifice has a larger distal diameter at the distal face than a proximal diameter at the proximal face, the tool body defining a plurality of tapered flutes wherein each of the tapers is larger at the distal face than the proximal face for receiving the wire twist connector running along through the orifice from the distal face to the proximal face;
the ratcheting handle comprising a handle first end and a handle second end for gripping about a linear axis, said handle first end defining the handle shaft end substantially about the linear axis of the handle for removeably securing the handle shaft end into the drive opening restricting linear motion wherein the ratcheting handle shaft allows for rotational motion about the handle axis; and
wherein the ratcheting handle shaft and tool body drive opening are removeably joined.

19. The wire twist connector tool of claim 18, wherein the plurality of tapered flutes run along the through orifice from the distal face to the proximal face in helical fashion.

20. The wire twist connector tool of claim 18, wherein the tool body defines a through orifice with pairs of stepped ridges that are arranged symmetrically for accommodating wings on an exterior of the wire twist connector.
